(19) United States
(12) Patent Application Publication
(10) Pub. No.: US 2024/0289764 A1
(43) Pub. Date: Aug. 29, 2024

(54) SYSTEMS, METHODS AND DEVICES FOR IMAGING-BASED DETECTION OF BARCODE MISPLACEMENT

(71) Applicant: ZEBRA TECHNOLOGIES CORPORATION, Lincolnshire, IL (US)

(72) Inventors: Yuri Astvatsaturov, Lake Forest, IL (US); Darran Michael Handshaw, Sound Beach, NY (US); Edward Barkan, Miller Place, NY (US)

(21) Appl. No.: 18/114,953

(22) Filed: Feb. 27, 2023

(51) Int. Cl. G06Q 20/20; G06K 7/14

(52) U.S. Cl. CPC G06Q 20/208; G06K 7/1443

(57) ABSTRACT

An example system for monitoring instances of barcode misplacement, comprising: one or more cameras; one or more processors; and one or more memories storing instructions that, when executed by the one or more processors, cause the one or more processors to: capture, by the one or more cameras, one or more images associated with a product scanning region of a indicia reader; analyze the one or more images to identify an indicia in the one or more images; responsive to identifying the indicia in the one or more images, analyze the one or more images to determine if the indicia is positioned on an appendage; and responsive to determining that the indicia is positioned on the appendage, trigger one or more mitigation actions.

### BACKGROUND

It is important that barcodes or other indicia associated with inventory management remain affixed to their respective items. There exists a need for systems and methods that can monitor instances of barcode misplacement.

### SUMMARY

In an embodiment, the present invention is a system for detecting instances of ticket switching involving an operator's appendage, comprising: one or more cameras; one or more processors; and one or more memories storing instructions that, when executed by the one or more processors, cause the one or more processors to: capture, by the one or more cameras, one or more images associated with a product scanning region of a indicia reader; analyze the one or more images to identify an indicia in the one or more images; responsive to identifying the indicia in the one or more images, analyze the one or more images to determine if the indicia is positioned on an appendage; and responsive to determining that the indicia is positioned on the appendage, trigger one or more mitigation actions.

In a variation of this embodiment, the one or more cameras include one or more two-dimensional cameras and one or more three-dimensional cameras, and analyzing the one or more images to determine if the indicia is positioned on the appendage includes: identifying, based on the one or more images captured by the one or more two-dimensional cameras, a two-dimensional position of the indicia in a spatial area associated with the product scanning region; generating, based on the one or more images captured by the one or more three-dimensional cameras, a three-dimensional representation of the spatial area associated with the product scanning region, the three-dimensional representation of the spatial area associated with the product scanning region including a three-dimensional representation of the appendage in the spatial area associated with the product scanning region; mapping the two-dimensional position of the indicia in the three-dimensional representation of the spatial area associated with the product scanning region; and determining if the indicia is positioned on the appendage based on comparing the mapping of the two-dimensional position of the indicia in the three-dimensional representation of the spatial area associated with the product scanning region to the three-dimensional representation of the appendage in the spatial area associated with the product scanning region.

Furthermore, in a variation of this embodiment, analyzing the one or more images captured by the one or more cameras to determine if the indicia is positioned on the appendage includes: analyzing the one or more images captured by the one or more cameras to identify the appendage, and at least one of a set of edges or a set of borders associated with the indicia, in the one or more images; and determining that the appendage at least one of: (i) touches the at least one of the set of edges or the set of borders associated with the indicia, or (ii) traverses the indicia, in the one or more images.

Additionally, in a variation of this embodiment, analyzing the one or more images captured by the one or more cameras to determine if the indicia is positioned on the appendage includes: analyzing the one or more images captured by the one or more cameras to identify blood vessels of an appendage, in the one or more images; and determining that the blood vessels of the appendage at least one of: (i) touch at least one of the set of edges or the set of borders associated with the indicia, or (ii) traverse the indicia, in the one or more images.

Furthermore, in a variation of this embodiment, analyzing the one or more images captured by the one or more cameras to determine if the indicia is positioned on the appendage includes: analyzing the one or more images captured by the one or more cameras to identify hairs of an appendage in the one or more images; and determining that the hairs of the appendage at least one of: (i) touch the at least one of a set of edges or a set of borders associated with the indicia, or (ii) traverse the indicia, in the one or more images.

Moreover, in a variation of this embodiment, analyzing the one or more images captured by the one or more cameras to determine if the indicia is positioned on the appendage includes: analyzing the one or more images captured by the one or more cameras to identify palm lines of an appendage in the one or more images; and determining that the palm lines of the appendage at least one of: (i) touch the at least one of a set of edges or a set of borders associated with the indicia, or (ii) traverse the indicia, in the one or more images.

Furthermore, in a variation of this embodiment, the one or more cameras include thermal cameras, and analyzing the one or more images to determine if the indicia is positioned on the appendage includes analyzing one or more images captured by the one or more thermal cameras to determine if the indicia is positioned on the appendage. For instance, analyzing the one or more images captured by the one or more thermal cameras to determine if the indicia is positioned on the appendage may include determining that a heat signature consistent with an appendage is associated with the indicia in the one or more images.

Additionally, in a variation of this embodiment, the system further includes an infrared illuminator configured to provide infrared light to the product scanning region, and the one or more cameras include one or more infrared cameras, and analyzing the one or more images captured by the one or more infrared cameras to determine if the indicia is positioned on the appendage includes identifying one or more blood vessels of an appendage in the images captured by the one or more infrared cameras that at least one of: (i) touch the at least one of a set of edges or a set of borders associated with the indicia, or (ii) traverse the indicia, in the one or more images.

Additionally, in a variation of this embodiment, the mitigation actions include at least one of: (i) pausing a transaction associated with the indicia; (ii) generating an alert to an employee associated with the indicia reader; (iii) capturing, by the one or more cameras, an image or a video of an individual present at the indicia reader at the time that the indicia is decoded; or (iv) preventing future transactions of an individual present at the indicia reader at a time that the indicia is decoded.

In another embodiment, the present invention is a method for detecting instances of ticket switching involving an operator's appendage, comprising: capturing, by one or more cameras, one or more images associated with a product scanning region of a indicia reader; analyzing, by one or more processors, the one or more images to identify an indicia in the one or more images; responsive to identifying the indicia in the one or more images, analyzing, by the one or more processors, the one or more images to determine if the indicia is positioned on an appendage; and responsive to determining that the indicia is positioned on the appendage, triggering, by the one or more processors, one or more mitigation actions.

In a variation of this embodiment, the one or more cameras include one or more two-dimensional cameras and one or more three-dimensional cameras, and analyzing the one or more images to determine if the indicia is positioned on the appendage includes: identifying, based on the one or more images captured by the one or more two-dimensional cameras, a two-dimensional position of the indicia in a spatial area associated with the product scanning region; generating, based on the one or more images captured by the one or more three-dimensional cameras, a three-dimensional representation of the spatial area associated with the product scanning region, the three-dimensional representation of the spatial area associated with the product scanning region including a three-dimensional representation of the appendage in the spatial area associated with the product scanning region; mapping the two-dimensional position of the indicia in the three-dimensional representation of the spatial area associated with the product scanning region; and determining if the indicia is positioned on the appendage based on comparing the mapping of the two-dimensional position of the indicia in the three-dimensional representation of the spatial area associated with the product scanning region to the three-dimensional representation of the appendage in the spatial area associated with the product scanning region.

Furthermore, in a variation of this embodiment, analyzing the one or more images captured by the one or more cameras to determine if the indicia is positioned on the appendage includes: analyzing the one or more images captured by the one or more cameras to identify the appendage, and at least one of a set of edges or a set of borders associated with the indicia, in the one or more images; and determining that the appendage at least one of: (i) touches the at least one of the set of edges or the set of borders associated with the indicia, or (ii) traverses the indicia, in the one or more images.

Moreover, in a variation of this embodiment, analyzing the one or more images captured by the one or more cameras to determine if the indicia is positioned on the appendage includes: analyzing the one or more images captured by the one or more cameras to identify hairs of an appendage in the one or more images; and determining that the hairs of the appendage at least one of: (i) touch the at least one of a set of edges or a set of borders associated with the indicia, or (ii) traverse the indicia, in the one or more images.

Additionally, in a variation of this embodiment, analyzing the one or more images captured by the one or more cameras to determine if the indicia is positioned on the appendage includes: analyzing the one or more images captured by the one or more cameras to identify blood vessels of an appendage, in the one or more images; and determining that the blood vessels of the appendage at least one of: (i) touch at least one of the set of edges or the set of borders associated with the indicia, or (ii) traverse the indicia, in the one or more images.

Moreover, in a variation of this embodiment, analyzing the one or more images captured by the one or more cameras to determine if the indicia is positioned on the appendage includes: analyzing the one or more images captured by the one or more cameras to identify palm lines of an appendage in the one or more images; and determining that the palm lines of the appendage at least one of: (i) touch the at least one of a set of edges or a set of borders associated with the indicia, or (ii) traverse the indicia, in the one or more images.

Furthermore, in a variation of this embodiment, the one or more cameras include thermal cameras, and analyzing the one or more images to determine if the indicia is positioned on the appendage includes analyzing one or more images captured by the one or more thermal cameras to determine if the indicia is positioned on the appendage. For instance, analyzing the one or more images captured by the one or more thermal cameras to determine if the indicia is positioned on the appendage may include determining that a heat signature consistent with an appendage is associated with the indicia in the one or more images.

Additionally, in a variation of this embodiment, the one or more cameras include one or more infrared cameras configured to capture images of the product scanning region as an infrared illuminator provides infrared light to the product scanning region, and analyzing the one or more images captured by the one or more infrared cameras to determine if the indicia is positioned on the appendage includes identifying one or more blood vessels of an appendage in the images captured by the one or more infrared cameras that at least one of: (i) touch the at least one of a set of edges or a set of borders associated with the indicia, or (ii) traverse the indicia, in the one or more images.

Additionally, in a variation of this embodiment, the mitigation actions include at least one of: (i) pausing a transaction associated with the indicia; (ii) generating an alert to an employee associated with the indicia reader; (iii) capturing, by the one or more cameras, an image or a video of an individual present at the indicia reader at the time that the indicia is decoded; or (iv) preventing future transactions of an individual present at the indicia reader at a time that the indicia is decoded.

In another embodiment, the present invention is a non-transitory computer-readable medium storing instructions for detecting instances of ticket switching involving an operator's appendage, that, when executed by one or more processors, cause the one or more processors to: cause one or more processors to capture one or more images associated with a product scanning region of a indicia reader; analyze the one or more images to identify an indicia in the one or more images; responsive to identifying the indicia in the one or more images, analyze the one or more images to determine if the indicia is positioned on an appendage; and responsive to determining that the indicia is positioned on the appendage, trigger one or more mitigation actions.

In a variation of this embodiment, the one or more cameras include one or more two-dimensional cameras and one or more three-dimensional cameras, and analyzing the one or more images to determine if the indicia is positioned on the appendage includes: identifying, based on the one or more images captured by the one or more two-dimensional cameras, a two-dimensional position of the indicia in a spatial area associated with the product scanning region; generating, based on the one or more images captured by the one or more three-dimensional cameras, a three-dimensional representation of the spatial area associated with the product scanning region, the three-dimensional representation of the spatial area associated with the product scanning region including a three-dimensional representation of the appendage in the spatial area associated with the product scanning region; mapping the two-dimensional position of the indicia in the three-dimensional representation of the spatial area associated with the product scanning region; and determining if the indicia is positioned on the appendage based on comparing the mapping of the two-dimensional position of the indicia in the three-dimensional representation of the spatial area associated with the product scanning region to the three-dimensional representation of the appendage in the spatial area associated with the product scanning region.

Furthermore, in a variation of this embodiment, analyzing the one or more images captured by the one or more cameras to determine if the indicia is positioned on the appendage includes: analyzing the one or more images captured by the one or more cameras to identify the appendage, and at least one of a set of edges or a set of borders associated with the indicia, in the one or more images; and determining that the appendage at least one of: (i) touches the at least one of the set of edges or the set of borders associated with the indicia, or (ii) traverses the indicia, in the one or more images.

Additionally, in a variation of this embodiment, analyzing the one or more images captured by the one or more cameras to determine if the indicia is positioned on the appendage includes: analyzing the one or more images captured by the one or more cameras to identify blood vessels of an appendage, in the one or more images; and determining that the blood vessels of the appendage at least one of: (i) touch at least one of the set of edges or the set of borders associated with the indicia, or (ii) traverse the indicia, in the one or more images.

Moreover, in a variation of this embodiment, analyzing the one or more images captured by the one or more cameras to determine if the indicia is positioned on the appendage includes: analyzing the one or more images captured by the one or more cameras to identify palm lines of an appendage in the one or more images; and determining that the palm lines of the appendage at least one of: (i) touch the at least one of a set of edges or a set of borders associated with the indicia, or (ii) traverse the indicia, in the one or more images.

Furthermore, in a variation of this embodiment, analyzing the one or more images captured by the one or more cameras to determine if the indicia is positioned on the appendage includes: analyzing the one or more images captured by the one or more cameras to identify hairs of an appendage in the one or more images; and determining that the hairs of the appendage at least one of: (i) touch the at least one of a set of edges or a set of borders associated with the indicia, or (ii) traverse the indicia, in the one or more images.

Furthermore, in a variation of this embodiment, the one or more cameras include thermal cameras, and analyzing the one or more images to determine if the indicia is positioned on the appendage includes analyzing one or more images captured by the one or more thermal cameras to determine if the indicia is positioned on the appendage. For instance, analyzing the one or more images captured by the one or more thermal cameras to determine if the indicia is positioned on the appendage may include determining that a heat signature consistent with an appendage is associated with the indicia in the one or more images.

Additionally, in a variation of this embodiment, the one or more cameras include one or more infrared cameras configured to capture images of the product scanning region as an infrared illuminator provides infrared light to the product scanning region, and analyzing the one or more images captured by the one or more infrared cameras to determine if the indicia is positioned on the appendage includes identifying one or more blood vessels of an appendage in the images captured by the one or more infrared cameras that at least one of: (i) touch the at least one of a set of edges or a set of borders associated with the indicia, or (ii) traverse the indicia, in the one or more images.

Furthermore, in a variation of this embodiment, the mitigation actions include at least one of: (i) pausing a transaction associated with the indicia; (ii) generating an alert to an employee associated with the indicia reader; (iii) capturing, by the one or more cameras, an image or a video of an individual present at the indicia reader at the time that the indicia is decoded; or (iv) preventing future transactions of an individual present at the indicia reader at a time that the indicia is decoded.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A is a perspective view of an example imaging system, implemented in an example point-of-sale (POS) system, having a bi-optical (also referred to as “bi-optic”) imager, showing the proper capture of images of an object and an indicia attached thereto.

FIG. 1B is a perspective view of an example imaging system as shown at FIG. 1A, showing the capture of an image of an appendage and an indicia attached thereto.

FIG. 2 illustrates a block diagram of an example system for implementing example methods and/or operations described herein including techniques for detecting instances of ticket switching involving an operator's appendage.

FIG. 3 illustrates an example appendage to which an indicia is affixed.

FIG. 4 illustrates a block diagram of an example process as may be implemented by the system of FIG. 2, for implementing example methods and/or operations described herein including techniques for detecting instances of ticket switching involving an operator's appendage.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As discussed above, it is important that barcodes or other indicia associated with inventory management remain affixed to their respective items. The present disclosure provides techniques for detecting instances of barcode misplacement, e.g., in which an indicia (such as a barcode, QR code, or other visual symbology that encodes a payload) is affixed to an operator's appendage (e.g., hand, arm, etc.) and taking mitigation steps based on detecting such instances of barcode misplacement. Compared to methods that involve comparing images of an item associated with an indicia at a indicia reader to images or characteristics of an item that is supposed to be associated with the indicia from a database, the present techniques involve detecting that the indicia is affixed to a user's appendage and taking mitigation steps based on this detection. Thus, the present techniques may have advantages compared to techniques that require the use of a database of images or characteristics of items associated with each indicia, or computationally-intensive comparisons between images or characteristics from such a database and images captured at the indicia reader.

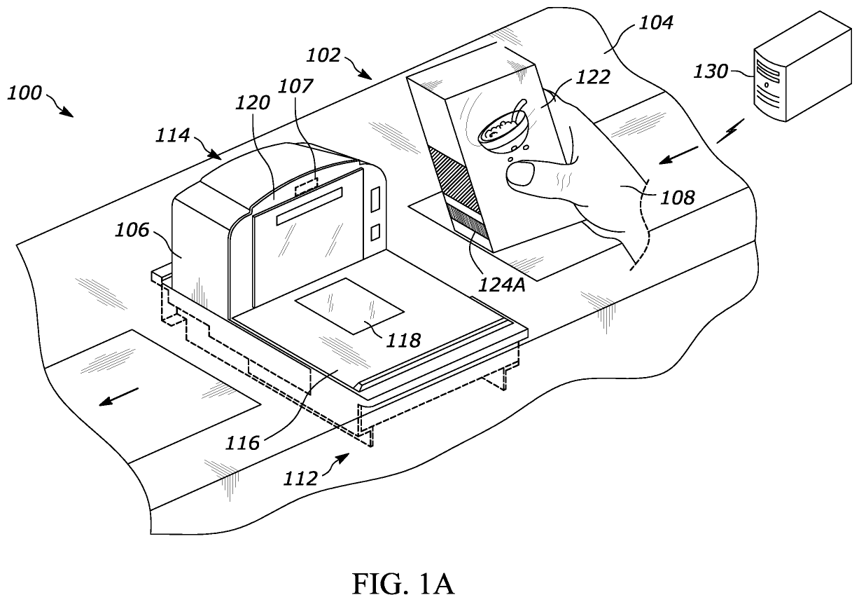

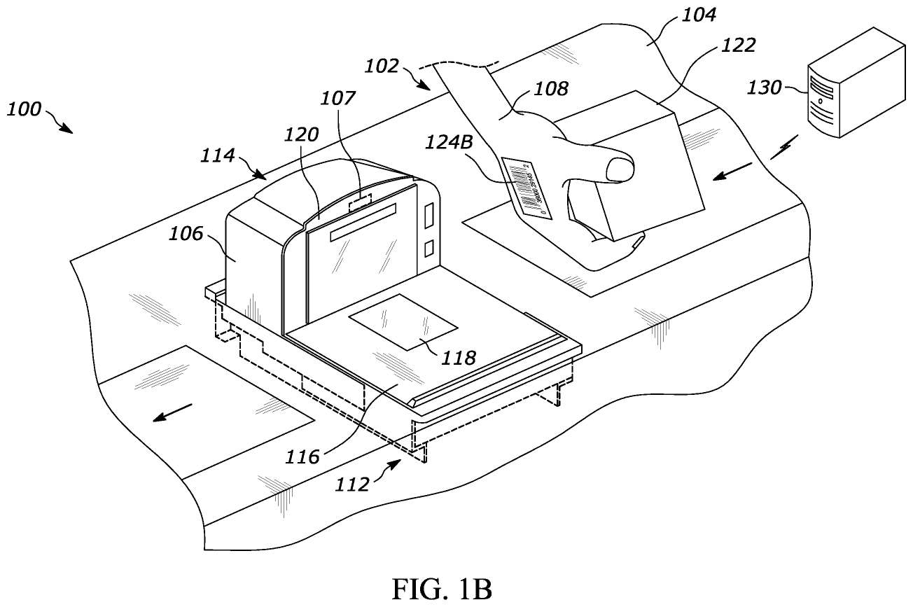

FIGS. 1A and 1B illustrate perspective views of an example imaging system capable of implementing operations of the example methods described herein, as may be represented by the flowcharts of the drawings that accompany this description. In the illustrated examples, an imaging system 100 is in the form of a indicia reader, having a workstation 102 with a counter 104, and a bi-optical (also referred to as “bi-optic”) indicia reader 106.

Imaging systems herein may include any number of imagers housed in any number of different devices. While FIGS. 1A and 1B illustrate an example bi-optic indicia reader 106 as the imager, in other examples, the imager may be handheld device, such as handheld barcode reader, or a fixed imager, such as a barcode reader held in place in a base and operated within what is termed a “presentation mode,” a slot scanner, or any other suitable indicia reader.

In the illustrated example, the indicia reader 106 includes a lower housing 112 and a raised housing 114. The lower housing 112 may be referred to as a first housing portion and the raised housing 114 may be referred to as a tower or a second housing portion. The lower housing 112 includes a top portion 116 with a first optically transmissive window 118 positioned therein along a generally horizontal plane relative to the overall configuration and placement of the indicia reader 106. In some examples, the top portion 116 may include a removable or a non-removable platter (e.g., a weighing platter including an electronic weighing scale).

In the illustrated example of FIG. 1A, the indicia reader 106 is configured to capture images of objects, in particular an item 122, such as, e.g., a package or a produce item, held in the appendage 108 of a user, passing through a product scanning region of the indicia reader 106. For example, the indicia reader 106 may capture these images of the item 122 through one of the first and second optically transmissive windows 118, 120. For example, image capture may be done by positioning the item 122 within the fields of view (FOV) of one or more digital imaging sensor(s) housed inside the indicia reader 106. The indicia reader 106 captures images of items 122 passing through a product scanning region of the indicia reader, and images of an indicia 124A (such as a barcode, QR code, or other visual symbology that encodes a payload) attached thereto, through these windows 118, 120. For instance, these digital imaging sensors may include one or more black-and-white cameras, one or more color cameras, one or more thermal cameras, one or more infrared cameras, etc. Moreover, these digital imaging sensors may be positioned at various locations inside and/or near the indicia reader 106.

In the illustrated example of FIG. 1B, as in the illustrated example of FIG. 1A, the indicia reader 106 is configured to capture images of objects passing through the product scanning region of the indicia reader, in a similar manner as discussed above with respect to FIG. 1A. However, as shown in the illustrated example of FIG. 1B, a user's appendage 108 may cover the item 122 and any indicia 124A that may be associated with the item, or otherwise position the item 122 and any indicia 124A that may be associated with the item so that images of the indicia 124A are not captured by the digital imaging sensors of the indicia reader 106. Furthermore, a different indicia 124B is affixed or imprinted upon the user's appendage 108, such that the indicia reader 106 captures images of the user's appendage 108 and/or the indicia 124B attached thereto rather than the item 122 and/or the indicia 124A attached thereto.

In the illustrated examples of FIGS. 1A and 1B, the imaging system 100 includes a server 130 communicatively coupled to the indicia reader 106 through a wired or wireless communication link. In some examples, the server 130 is a remote server, while in other examples, the server 130 is a local server. The server 130 is communicatively coupled to a plurality of imaging systems 100 positioned at checkout area of a facility, for example. In some examples, the server 130 is implemented as an inventory management server that generates and compares object identification data. In some examples, the server 130 is accessible by a manager for monitoring operation and improper product scanning by the imaging system 100.

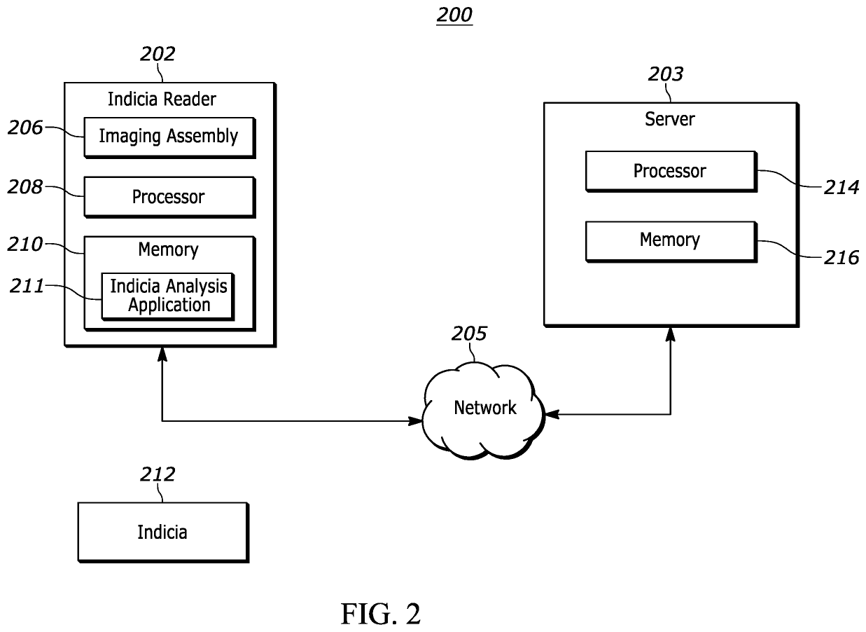

FIG. 2 illustrates an example system where embodiments of the present invention may be implemented. In the present example, the environment is provided in the form of a facility having one or more scanning locations 200 corresponding to an imaging system, such as the imaging system 100 of FIG. 1, where various items may be scanned for completing a purchase of an item.

In the illustrated example, the location 200 is a POS location and includes a indicia reader 202 and a server 203, which may communicate via a network 205 (and/or via a wired interface, not shown). In some embodiments, the device referred to as “server 203” may be a single board computer (SBC) 203. The server 203 may be local to the indicia reader 202, or may even be part of the indicia reader 202 in some embodiments. In other embodiments, the server 203 may be located remotely from the indicia reader 202. The indicia reader 202 may include a network interface (not shown) that represents any suitable type of communication interface(s) (e.g., wired interfaces such as Ethernet or USB, and/or any suitable wireless interfaces) configured to operate in accordance with any suitable protocol(s) for communicating with the server 203 over the network 205.

The indicia reader 202 may include an imaging assembly 206, one or more processors 208, and a memory 210. The imaging assembly 206 may include one or more digital imaging sensors, which may include one or more black-and-white cameras, one or more color cameras, one or more thermal cameras, one or more infrared cameras, etc. One or more of the digital imaging sensors of the imaging assembly 206 may be optimized to capture image data for decoding an indicia 212 (such as a barcode, QR code, or other visual symbology that encodes a payload). Additionally, one or more of the digital imaging sensors of the imaging assembly 206 may be optimized to capture image data for vision techniques, such as identifying objects or characteristics thereof.

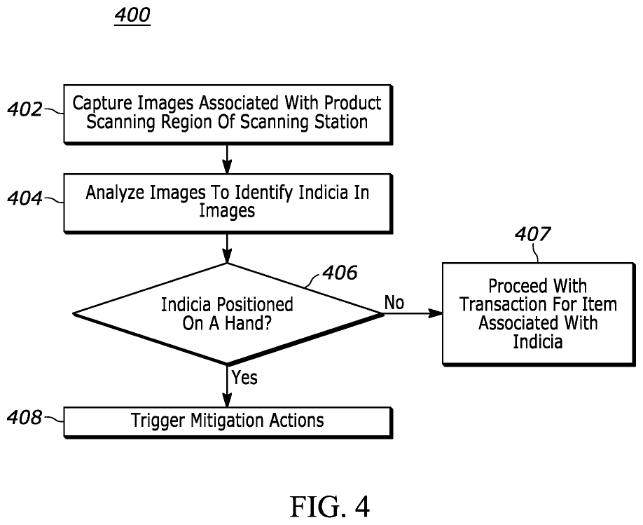

The one or more processors 208 may be, for example, one or more microprocessors, controllers, and/or any suitable type of processors. The memory 210 may be accessible by the one or more processors 208 (e.g., via a memory controller). The one or more processors 208 may interact with the memory 210 to obtain, for example, machine-readable instructions stored in the memory 210 corresponding to, for example, the operations represented by the flowcharts of this disclosure, including those of FIG. 4. In particular, the instructions stored in the memory 210, when executed by the one or more processors 208, may cause the one or more processors 208 to analyze image data associated with the indicia 212 to decode the indicia 212 and/or identify characteristics of an object to which the indicia 212 is attached. Furthermore, the instructions stored in the memory 210, when executed by the one or more processors 208, may cause the one or more processors 208 to generate a signal (e.g., to be transmitted to the server 203) associated with a successful decoding of the indicia 212. The signal may include an indication of information associated with the decoded indicia 212.

Furthermore, the instructions stored in the memory 210 may include instructions for executing an indicia analysis application 211.

Generally speaking, the indicia analysis application 211 may be configured to analyze image data associated with the indicia 212 (e.g., image data captured by the imaging assembly 206 in order to determine whether the indicia 212 is affixed to an appendage (e.g., as a sticker, as a stamp, as a tattoo, etc.), rather than affixed to an item to be purchased.

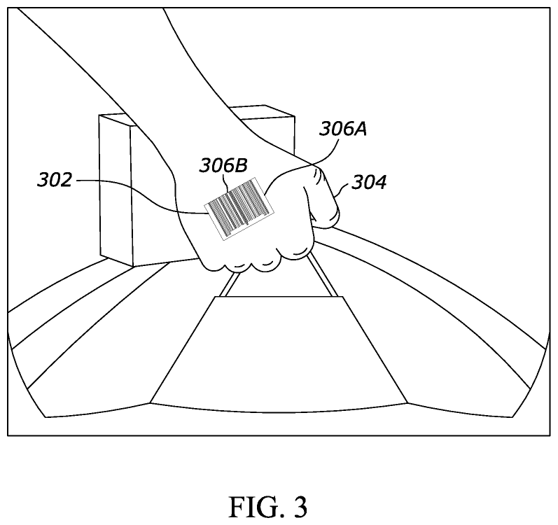

For example, referring now to FIG. 3, an indicia 302 that is affixed to an appendage 304 may include one or more edges or borders, such as an edge/border 306A, an edge/border 306B, etc. In some example, in images associated with the indicia 302, the appendage may touch or traverse the edges/borders 306A, 306B of the indicia 302. In other examples, the appendage 304 may not actually touch or traverse the edges/borders 306A, 306B of the indicia 302, but may be within a short threshold distance (e.g., 2 mm, 3 mm, etc.) of the edges/borders 306A, 306B of the indicia 302, e.g., due to white space of a sticker including the indicia 302, between the edge 306A of the indicia and the appendage 304 as it appears in the image.

Referring back to FIG. 2, the indicia analysis application 211 may determine whether a shape, size, color, temperature, and/or other characteristics of an object that touches or traverses the edges/borders of the indicia 212 is consistent with the shape, size, color, temperature and/or other characteristics of an appendage. Furthermore, in some examples, the indicia analysis application 211 may analyze images associated with the indicia 212 in order to identify one or more sides and/or edges of the indicia 212, and may determine whether any appendages appear in the images based on shapes, sizes, colors, temperatures, and/or other characteristics of objects in the images. The indicia analysis application 218 may then determine whether any identified appendages in the images touch or traverse the one or more sides and/or edges of the indicia 212.

For instance, the indicia analysis application 211 may determine the shapes, sizes, colors, and/or other characteristics of any objects appearing in the images associated with the indicia 212 based on analyzing two-dimensional and/or three-dimensional images captured by the imaging assembly 206, and may compare the shapes, sizes, and/or colors of the objects to known ranges of shapes, sizes, colors, and/or other characteristics for appendages. The indicia analysis application 211 may determine the temperatures of any objects appearing in the images associated with the indicia 212 based on analyzing thermal images captured by the imaging assembly 206. Additionally, the indicia analysis application 211 may identify blood vessels (e.g., palm veins) in the images associated with the indicia based on analyzing infrared images captured by the imaging assembly 206 when infrared illumination is provided the product scanning region where the images are captured. Other characteristics of objects in the images that may be indicative of or associated with appendages may include, for instance, hairs, wrinkles at knuckles or joints, palm lines, veins, nails, freckles, or other blemishes, etc.

In some examples, the indicia analysis application 211 may be able to use a single image, or a single type of image (two-dimensional, three-dimensional, thermal, color, black-and-white, or otherwise) associated with an indicia 212 to identify whether the indicia 212 is affixed to an appendage. In other examples, the indicia analysis application 211 may use multiple images, and/or multiple types of images associated with an indicia 212, to identify whether the indicia 212 is affixed to an appendage. For instance, in some cases, features from one image (e.g., one type of image) may be mapped to another image (e.g., another type of image). For example, edges and/or sides of an indicia 212 may be identified in a two-dimensional color image, and the location of the indicia 212 in the two-dimensional color image may be mapped to a three-dimensional image captured at the same time or within a threshold period of time in order to determine a likelihood that the indicia 212 is affixed to an appendage based on whether the edges and/or sides of the indicia 212 traverse or touch an area in the three-dimensional image associated with shape, size, color, and/or other characteristics of an appendage. Similarly, edges and/or sides of an indicia 212 may be identified in a two-dimensional color image, and the location of the indicia 212 in the two-dimensional color image may be mapped to a thermal image captured at the same time or within a threshold period of time in order to determine a likelihood that the indicia 212 is affixed to an appendage based on whether the edges and/or sides of the indicia 212 traverse or touch an area in the thermal image associated with temperature characteristics of an appendage.

If the indicia analysis application 211 determines that the indicia 212 is attached to an appendage (e.g., the likelihood that the indicia 212 is affixed to an appendage is greater than a threshold likelihood), the indicia analysis application 218 may trigger one or more mitigation actions. For instance, in some examples, the mitigation actions may include the indicia reader refraining from transmitting an indication of a successful decode of the indicia to a host server. Additionally, in some examples, the mitigation actions may include the imaging assembly 206 capturing an image or a video of an individual present at the indicia reader at the time that the indicia is decoded. Moreover, the mitigation actions may include the indicia analysis application 218 triggering an audible or visible alert, e.g., via an audible or visual indicator associated with the indicia reader 202, such as an LED. Furthermore, in some examples, the mitigation actions may include the indicia analysis application 218 sending a signal to the host server 203, such that the host server 203 may perform other mitigation actions, such as pausing a transaction associated with the indicia 212, generating an alert to an employee associated with the indicia reader 202, preventing future transactions of an individual who is present at the indicia reader at a time that the indicia 212 is decoded, marking a receipt of a transaction associated with the indicia 212, etc.

Additionally, or alternatively, machine-readable instructions corresponding to the example operations described herein may be stored on one or more removable media (e.g., a compact disc, a digital versatile disc, removable flash memory, etc.) that may be coupled to the indicia reader 202 to provide access to the machine-readable instructions stored thereon.

The server 203 may include one or more processors 214, which may be, for example, one or more microprocessors, controllers, and/or any suitable type of processors, and a memory 216 accessible by the one or more processors 214 (e.g., via a memory controller). The one or more processors 214 may interact with the memory 216 to obtain, for example, machine-readable instructions stored in the memory 216 corresponding to, for example, the operations represented by the flowcharts of this disclosure, including those of FIG. 4. In particular, the instructions stored in the memory 216, when executed by the one or more processors 214, may cause the one or more processors 214 to receive and analyze signals generated by the indicia reader 202. For instance, the host server 203 may receive signals from the indicia reader 202 indicative of successful decoding of an indicia 212. Moreover, in some examples, the host server 203 may receive signals from the indicia reader 202 that trigger the host server 203 to take one or more mitigation actions in the event that the indicia 212 is affixed to an appendage, such as pausing a transaction associated with the indicia 212, generating an alert to an employee associated with the indicia reader 202, preventing future transactions of an individual who is present at the indicia reader 202 at a time that the indicia 212 is decoded, marking a receipt of a transaction associated with the indicia 212, etc. For instance, the instructions stored in the memory 216, when executed by the one or more processors 214, may cause the one or more processors 214 to analyze images captured by the imaging assembly 206 using facial recognition techniques, or other user identification techniques, to identify the individual present at the indicia reader at the time that the indicia 212 in question is passing through the product scanning region, and preventing future transactions associated with that individual from proceeding.

While the indicia analysis application 211 is shown as being stored on the memory 210 and executed by the processor 208, in some examples, the indicia analysis application 211, or an instance of the indicia analysis application 211, may be stored on the memory 216, or another memory of the server 203, and executed by the processor 214, or another processor of the server 203.

Moreover, in some examples, additional or alternative applications may be included in various embodiments. Furthermore, in some embodiments, applications or operations described herein as being performed by the processor 208 may be performed by the processor 214, and vice versa. Additionally or alternatively, machine-readable instructions corresponding to the example operations described herein may be stored on one or more removable media (e.g., a compact disc, a digital versatile disc, removable flash memory, etc.) that may be coupled to the server 203 to provide access to the machine-readable instructions stored thereon.

FIG. 4 illustrates a block diagram of an example process 400 as may be implemented by the system of FIG. 2, for implementing example methods and/or operations described herein including techniques for detecting instances of ticket switching involving an operator's appendage as may be performed by the imaging system 100 and server 130 in FIGS. 1A and 1B, or by the indicia reader 202 and server 203 in FIG. 2.

At block 402, one or more images associated with a product scanning region of a indicia reader may be captured by one or more cameras (e.g., of the imaging assembly 206). The cameras may include, for instance, two-dimensional cameras, three-dimensional cameras, color cameras, black-and-white cameras, thermal cameras, or other types of cameras.

At block 404, the one or more images may be analyzed to identify an indicia (e.g., a barcode, QR code, etc.) in the one or more images, as well as an appendage in the one or more images.

Identifying the indicia may include identifying one or more edges/borders of the indicia. Moreover, in some examples, identifying the indicia may include mapping the indicia as identified in one image (e.g., an image captured by type of camera) to a location in another image (e.g., an image captured by another type of camera). For instance, an image of the indicia captured by a two-dimensional camera may be mapped to a location in a three-dimensional image captured by a three-dimensional camera. As another example, an image of the indicia captured by a two-dimensional camera may be mapped to a location in a thermal image captured by a thermal camera.

At block 406, a determination may be made as to whether the indicia is positioned on an appendage. Determining that the indicia is positioned on an appendage may include, for instance, analyzing two-dimensional and/or three-dimensional images associated with the indicia, or to which the indicia is mapped, to determine the shapes, sizes, colors, and/or other characteristics of any objects appearing in the images associated with the indicia, and comparing the shapes, sizes, and/or colors of the objects to known ranges of shapes, sizes, colors, and/or other characteristics associated with appendages. Other characteristics of objects in the images that may be indicative of or associated with appendages may include, for instance, hairs, wrinkles at knuckles or joints, palm lines, blood vessels, nails, freckles or other blemishes, etc.

In some examples, the method 400 may include determining if the indicia is positioned on an appendage by determining whether the appendage touches at least one of edges/borders associated with the indicia, and/or traverses the indicia in the images.

Furthermore, in some examples, the method 400 may include determining if the indicia is positioned on an appendage by analyzing the images to identify blood vessels of the appendage in the one or more images, and determining whether one or more blood vessels of the appendage touch at least one of the edges/borders associated with the indicia and/or traverse the indicia in the images.

Moreover, in some examples, the method 400 may include determining if the indicia is positioned on an appendage by analyzing the images to identify palm lines of the appendage in the one or more images, and determining whether one or more palm lines of the appendage touch at least one of the edges/borders associated with the indicia and/or traverse the indicia in the images.

Similarly, in some examples, the method 400 may include determining if the indicia is positioned on an appendage by analyzing the images to identify hairs of the appendage in the one or more images, and determining whether one or more hairs of the appendage touch at least one of the edges/borders associated with the indicia and/or traverse the indicia in the images.

Additionally, in some examples, the method 400 may include determining if the indicia is positioned on an appendage by analyzing images captured by thermal cameras to identify the appendage, e.g., based on identifying areas of the thermal images having heat signatures consistent with an appendage, such as a hand or arm, and determining whether the areas of the thermal images having heat signatures consistent with the appendage touch or traverse a mapped location of the indicia (e.g., one or more borders and/or edges of the indicia) in the thermal images.

Furthermore, the method 400 may include determining if the indicia is positioned on an appendage by analyzing the images captured by infrared cameras (i.e., when infrared illumination is applied to the product scanning region where the images are captured) to identify blood vessels of the appendage, e.g., based on identifying one or more blood vessels of an appendage in the infrared images, and determining whether the blood vessels of the appendage touch or traverse a mapped location of the indicia (e.g., one or more borders and/or edges of the indicia) in the thermal images.

In some examples, the method 400 may include determining if the indicia is positioned on an appendage by identifying a two-dimensional position of the indicia in a spatial area associated with the product scanning region, e.g., based on images captured by the two-dimensional cameras, and generating a three-dimensional spatial representation of the spatial area associated with the product scanning region, e.g., based on images captured by the three-dimensional cameras. If the product scanning region includes an appendage, generating the three-dimensional spatial representation of the spatial area associated with the product scanning region may include generating a three-dimensional representation of the appendage in the three-dimensional spatial representation of the spatial area associated with the product scanning region. The method 400 may include mapping the two-dimensional position of the indicia to the three-dimensional representation of the spatial area associated with the product scanning region, and comparing the mapping of the two-dimensional position of the indicia in the three-dimensional representation of the spatial area associated with the product scanning region to the three-dimensional representation of the appendage in the spatial area associated with the product scanning region to determine if the indicia is positioned on the appendage.

If the indicia is not positioned on an appendage (block 406, NO), the process 400 may include performing additional steps in order to proceed with a transaction for an item that is associated with the indicia at block 407, including, for instance, sending an indication of a successful decode to a host server. If the indicia is positioned on an appendage (block 406, YES), one or more mitigation actions may be triggered at block 408.

For instance, in some examples, the mitigation actions may include the indicia reader refraining from transmitting an indication of a successful decode of the indicia to a host server. Additionally, in some examples, the mitigation actions may include the indicia reader capturing an image or a video of an individual present at the indicia reader at the time that the indicia is decoded. Moreover, the mitigation actions may include the indicia reader triggering an audible or visible alert, e.g., via an audible or visual indicator associated with the indicia reader, such as an LED. Furthermore, in some examples, the mitigation actions may include sending a signal to the host server, such that the host server may perform other mitigation actions, such as pausing a transaction associated with the indicia, generating an alert to an employee associated with the indicia reader, preventing future transactions of an individual who is present at the indicia reader at a time that the indicia is decoded, marking a receipt of a transaction associated with the indicia, etc.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A system for product scanning, comprising:
one or more cameras;
one or more processors; and
one or more memories storing instructions that, when executed by the one or more processors, cause the one or more processors to:
capture, by the one or more cameras, one or more images associated with a product scanning region of an indicia reader;
analyze the one or more images to identify an indicia in the one or more images;
responsive to identifying the indicia in the one or more images, analyze the one or more images to determine if the indicia is positioned on an appendage; and
responsive to determining that the indicia is positioned on the appendage, trigger one or more mitigation actions.

2. The system of claim 1, wherein the one or more cameras include one or more two-dimensional cameras and one or more three-dimensional cameras, and wherein analyzing the one or more images to determine if the indicia is positioned on the appendage includes:
identifying, based on the one or more images captured by the one or more two-dimensional cameras, a two-dimensional position of the indicia in a spatial area associated with the product scanning region;
generating, based on the one or more images captured by the one or more three-dimensional cameras, a three-dimensional representation of the spatial area associated with the product scanning region, the three-dimensional representation of the spatial area associated with the product scanning region including a three-dimensional representation of the appendage in the spatial area associated with the product scanning region;
mapping the two-dimensional position of the indicia in the three-dimensional representation of the spatial area associated with the product scanning region; and
determining if the indicia is positioned on the appendage based on comparing the mapping of the two-dimensional position of the indicia in the three-dimensional representation of the spatial area associated with the product scanning region to the three-dimensional representation of the appendage in the spatial area associated with the product scanning region.

3. The system of claim 1, wherein analyzing the one or more images captured by the one or more cameras to determine if the indicia is positioned on the appendage includes:
analyzing the one or more images captured by the one or more cameras to identify the appendage, and at least one of a set of edges or a set of borders associated with the indicia, in the one or more images; and
determining that the appendage at least one of: (i) touches the at least one of the set of edges or the set of borders associated with the indicia, or (ii) traverses the indicia, in the one or more images.

4. The system of claim 1, wherein analyzing the one or more images captured by the one or more cameras to determine if the indicia is positioned on the appendage includes:
analyzing the one or more images captured by the one or more cameras to identify blood vessels of an appendage, in the one or more images; and
determining that the blood vessels of the appendage at least one of: (i) touch at least one of the set of edges or the set of borders associated with the indicia, or (ii) traverse the indicia, in the one or more images.

5. The system of claim 1, wherein analyzing the one or more images captured by the one or more cameras to determine if the indicia is positioned on the appendage includes:
analyzing the one or more images captured by the one or more cameras to identify palm lines of an appendage in the one or more images; and
determining that the palm lines of the appendage at least one of: (i) touch the at least one of a set of edges or a set of borders associated with the indicia, or (ii) traverse the indicia, in the one or more images.

6. The system of claim 1, wherein analyzing the one or more images captured by the one or more cameras to determine if the indicia is positioned on the appendage includes:
analyzing the one or more images captured by the one or more cameras to identify hairs of an appendage in the one or more images; and
determining that the hairs of the appendage at least one of: (i) touch the at least one of a set of edges or a set of borders associated with the indicia, or (ii) traverse the indicia, in the one or more images.

7. The system of claim 1, wherein the one or more cameras include one or more thermal cameras, and wherein analyzing the one or more images to determine if the indicia is positioned on the appendage includes analyzing one or more images captured by the one or more thermal cameras to determine if the indicia is positioned on the appendage.

8. The system of claim 7, wherein analyzing the one or more images captured by the one or more thermal cameras to determine if the indicia is positioned on the appendage includes determining that a heat signature consistent with an appendage is associated with the indicia in the one or more images.

9. The system of claim 1, wherein the system further includes an infrared illuminator configured to provide infrared light to the product scanning region, and wherein the one or more cameras include one or more infrared cameras, and wherein analyzing the one or more images captured by the one or more infrared cameras to determine if the indicia is positioned on the appendage includes identifying one or more blood vessels of an appendage in the images captured by the one or more infrared cameras that at least one of: (i) touch the at least one of a set of edges or a set of borders associated with the indicia, or (ii) traverse the indicia, in the one or more images.

10. The system of claim 1, wherein the mitigation actions include at least one of: (i) pausing a transaction associated with the indicia; (ii) generating an alert to an employee associated with the indicia reader; (iii) capturing, by the one or more cameras, an image or a video of an individual present at the indicia reader at the time that the indicia is decoded; or (iv) preventing future transactions of an individual present at the indicia reader at a time that the indicia is decoded.

11. A method for product scanning, comprising:
capturing, by one or more cameras, one or more images associated with a product scanning region of an indicia reader;
analyzing, by one or more processors, the one or more images to identify an indicia in the one or more images;
responsive to identifying the indicia in the one or more images, analyzing, by the one or more processors, the one or more images to determine if the indicia is positioned on an appendage; and
responsive to determining that the indicia is positioned on the appendage, triggering, by the one or more processors, one or more mitigation actions.

12. The method of claim 11, wherein the one or more cameras include one or more two-dimensional cameras and one or more three-dimensional cameras, and wherein analyzing the one or more images to determine if the indicia is positioned on the appendage includes:
identifying, based on the one or more images captured by the one or more two-dimensional cameras, a two-dimensional position of the indicia in a spatial area associated with the product scanning region;
generating, based on the one or more images captured by the one or more three-dimensional cameras, a three-dimensional representation of the spatial area associated with the product scanning region, the three-dimensional representation of the spatial area associated with the product scanning region including a three-dimensional representation of the appendage in the spatial area associated with the product scanning region;
mapping the two-dimensional position of the indicia in the three-dimensional representation of the spatial area associated with the product scanning region; and
determining if the indicia is positioned on the appendage based on comparing the mapping of the two-dimensional position of the indicia in the three-dimensional representation of the spatial area associated with the product scanning region to the three-dimensional representation of the appendage in the spatial area associated with the product scanning region.

13. The method of claim 11, wherein analyzing the one or more images captured by the one or more cameras to determine if the indicia is positioned on the appendage includes:
analyzing the one or more images captured by the one or more cameras to identify the appendage, and at least one of a set of edges or a set of borders associated with the indicia, in the one or more images; and
determining that the appendage at least one of: (i) touches the at least one of the set of edges or the set of borders associated with the indicia, or (ii) traverses the indicia, in the one or more images.

14. The method of claim 11, wherein analyzing the one or more images captured by the one or more cameras to determine if the indicia is positioned on the appendage includes:
analyzing the one or more images captured by the one or more cameras to identify blood vessels of an appendage, in the one or more images; and
determining that the blood vessels of the appendage at least one of: (i) touch at least one of the set of edges or the set of borders associated with the indicia, or (ii) traverse the indicia, in the one or more images.

15. The method of claim 11, wherein analyzing the one or more images captured by the one or more cameras to determine if the indicia is positioned on the appendage includes:
analyzing the one or more images captured by the one or more cameras to identify palm lines of an appendage in the one or more images; and
determining that the palm lines of the appendage at least one of: (i) touch the at least one of a set of edges or a set of borders associated with the indicia, or (ii) traverse the indicia, in the one or more images.

16. The method of claim 11, wherein analyzing the one or more images captured by the one or more cameras to determine if the indicia is positioned on the appendage includes:
analyzing the one or more images captured by the one or more cameras to identify hairs of an appendage in the one or more images; and
determining that the hairs of the appendage at least one of: (i) touch the at least one of a set of edges or a set of borders associated with the indicia, or (ii) traverse the indicia, in the one or more images.

17. The method of claim 11, wherein the one or more cameras include one or more thermal cameras, and wherein analyzing the one or more images to determine if the indicia is positioned on the appendage includes analyzing one or more images captured by the one or more thermal cameras to determine if the indicia is positioned on the appendage.

18. The method of claim 11, wherein analyzing the one or more images captured by the one or more thermal cameras to determine if the indicia is positioned on the appendage includes determining that a heat signature consistent with an appendage is associated with the indicia in the one or more images.

19. The method of claim 18, wherein the one or more cameras include one or more infrared cameras configured to capture images of the product scanning region as an infrared illuminator provides infrared light to the product scanning region, and wherein analyzing the one or more images captured by the one or more infrared cameras to determine if the indicia is positioned on the appendage includes identifying one or more blood vessels of an appendage in the images captured by the one or more infrared cameras that at least one of: (i) touch the at least one of a set of edges or a set of borders associated with the indicia, or (ii) traverse the indicia, in the one or more images.

20. The method of claim 11, wherein the mitigation actions include at least one of: (i) pausing a transaction associated with the indicia; (ii) generating an alert to an employee associated with the indicia reader; (iii) capturing, by the one or more cameras, an image or a video of an individual present at the indicia reader at the time that the indicia is decoded; or (iv) preventing future transactions of an individual present at the indicia reader at a time that the indicia is decoded.

21. A non-transitory computer-readable medium storing instructions for product scanning, that, when executed by one or more processors, cause the one or more processors to:
cause one or more processors to capture one or more images associated with a product scanning region of an indicia reader;
analyze the one or more images to identify an indicia in the one or more images;
responsive to identifying the indicia in the one or more images, analyze the one or more images to determine if the indicia is positioned on an appendage; and
responsive to determining that the indicia is positioned on the appendage, trigger one or more mitigation actions.

22. The non-transitory computer-readable medium of claim 21, wherein the one or more cameras include one or more two-dimensional cameras and one or more three-dimensional cameras, and wherein analyzing the one or more images to determine if the indicia is positioned on the appendage includes:
identifying, based on the one or more images captured by the one or more two-dimensional cameras, a two-dimensional position of the indicia in a spatial area associated with the product scanning region;
generating, based on the one or more images captured by the one or more three-dimensional cameras, a three-dimensional representation of the spatial area associated with the product scanning region, the three-dimensional representation of the spatial area associated with the product scanning region including a three-dimensional representation of the appendage in the spatial area associated with the product scanning region;
mapping the two-dimensional position of the indicia in the three-dimensional representation of the spatial area associated with the product scanning region; and
determining if the indicia is positioned on the appendage based on comparing the mapping of the two-dimensional position of the indicia in the three-dimensional representation of the spatial area associated with the product scanning region to the three-dimensional representation of the appendage in the spatial area associated with the product scanning region.
